(19) United States
(12) Patent Application Publication
(10) Pub. No.: US 2007/0244868 A1
(43) Pub. Date: Oct. 18, 2007

(54) INTERNET BOOK MARKING AND SEARCH RESULTS DELIVERY

(76) Inventors: Michael L. Grubb, San Francisco, CA (US); Jonathan Gifford, San Francisco, CA (US); Jiye Yu, Menlo Park, CA (US)

Correspondence Address: IRELL & MANELLA LLP, 1800 AVENUE OF THE STARS, SUITE 900, LOS ANGELES, CA, 90067, US

(21) Appl. No.: 11/555,224

(22) Filed: Oct. 31, 2006

Related U.S. Application Data
(60) Provisional application No. 60/731,739, filed on Oct. 31, 2005.

(51) Int. Cl. G06F 17/30

(52) U.S. Cl. 707/3

(57) ABSTRACT

A method of enhancing search results provided over the Internet may include providing a service over the Internet to members of a group of service users, the service resulting in multiple selections of each of a plurality of web pages by different members of the group, maintaining a first database of web pages selected by members of the group, maintaining a first index of web pages from the first database excluding identification of members of the group, maintaining a global index of web pages, searching the first index and the global index in response to a query string provided by a search engine user and providing a search results set to the search engine user including search results from both the first index and the global index.

### CROSS REFERENCE TO RELATED APPLICATION

This application claims the benefit of U.S. provisional patent application Ser. No. 60/731,739 filed Oct. 31, 2005.

### BACKGROUND OF THE INVENTION

1. Field of the Invention

This invention is related to Internet book marking systems and search engines.

2. Description of the Prior Art

Internet users are provided with many conventional techniques for selectively saving and revisiting (i.e. book marking or adding favorites) the uniform resource locator (URL) addresses of web sites found during Internet searching on search engine sites. What are needed are improvements in such book marking and searching systems.

### BRIEF DESCRIPTION OF THE DRAWING(S)

FIG. 1 is a block diagram overview of an Internet book marking system and an associated search result delivery engine.

FIG. 2 is a block diagram overview of a more general search results delivery engine based on the system of FIG. 1.

### SUMMARY OF THE DISCLOSURE

In a first aspect, a method of enhancing search results provided over the Internet may include providing a service over the Internet to members of a group of service users, the service resulting in multiple selections of each of a plurality of web pages by different members of the group, maintaining a first database of web pages selected by members of the group, maintaining a first index of web pages from the first database excluding identification of members of the group, maintaining a larger, unrestricted or global index of web pages typically formed by crawling the entire web, searching the first index and the global index in response to a query string provided by a search engine user and providing a search results set to the search engine user including search results from both the first index and the global index.

The service may include providing book marking services to the group to allow each member of the group to retrieve links to web pages previously viewed by that member. A private archive may be maintained, exclusively searchable by each member, of web pages book marked by that member. An index of each member's private archive may be maintained. A search request from a particular member may be processed by searching the index of that member's private archive to provide a search results set and selectively providing, to that member, the web page corresponding to a link in the search results set from the archive or providing the web page currently corresponding to the link.

A common archive of web pages book marked by any member of the group may be maintained, unless marked private by that member. A web page bookmarked and not marked private by a first member of the group may be included in the common even if that web page was bookmarked and marked private by another member of the group. Recommendations may be provided to a member of the group of web pages of interest to that member of the group. The recommendations may be based on a predetermined measure related to popularity of the web pages recommended, or book marking of that page by other members of the group. Similarly, recommendations may be provided to a first member of the group of web pages bookmarked by a second member of the group if the first member subscribes to recommendations based on the second member's book marks. When a first member of the group performs an operation on a first web page on which a second member of the group has performed an operation, recommendations of other web pages in the common archives on which the second member has performed operations, may be provided to the first member. The operations performed may be selected from a group of operations comprising book marking, saving, viewing and accessing.

The book marking activity of a first member may be compared to the book marking activity of a second member so that book marks made by the second member may be recommended to the first member if a predetermined threshold of similarity is achieved. Recommendations may be provided to a member based on a likelihood of interest of each such recommendation to the member. Recommendations to a member may be sent upon the occurrence of a predetermined event, such as the completion of a period of time. Alternately, recommendations may be sent to a member in response to an action taken by the member, such as logging into the service, requesting recommendations and/or submitting a search request.

Metadata specified by a first member to be associated with a web page may be recorded in the private archive maintained for the first member. The metadata related to a web page book marked by a member may be automatically recorded so that the recorded metadata may be used to qualify for remuneration from an entity offering remuneration associated with activities related to the web page.

### DETAILED DESCRIPTION OF THE EMBODIMENT(S)

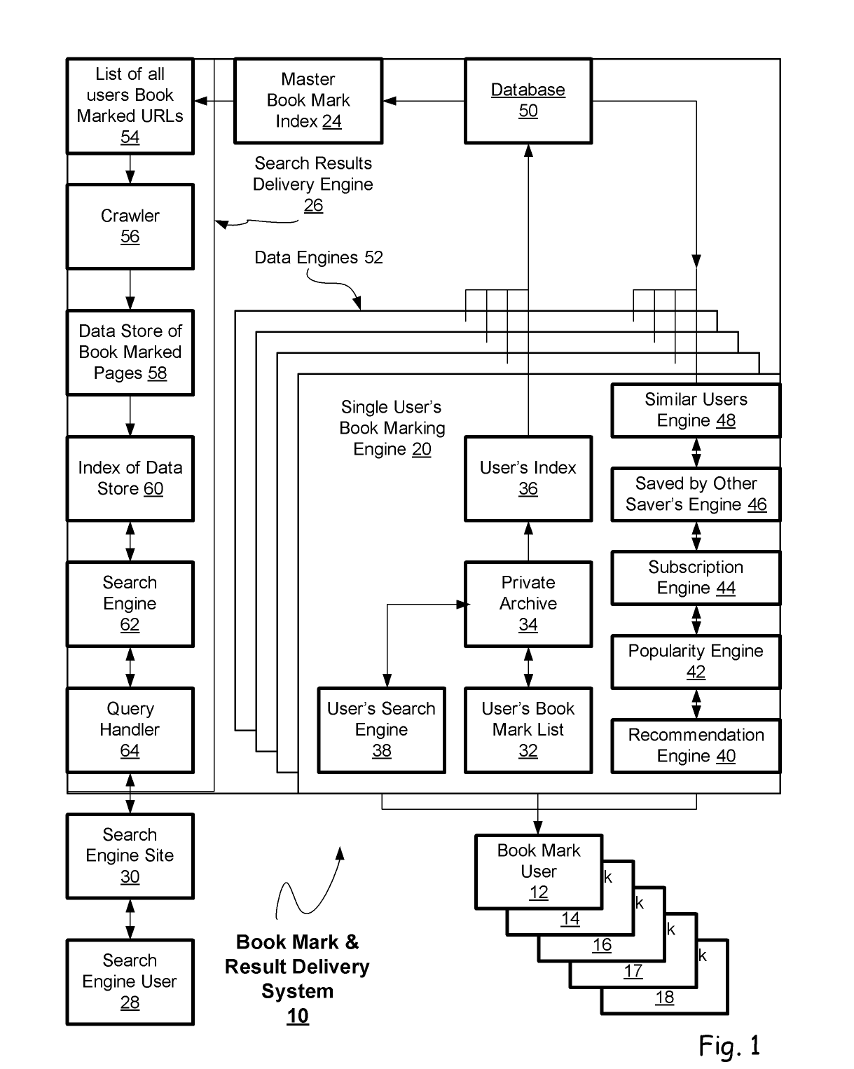

Referring now to FIG. 1, book mark and result delivery system 10 includes a book marking engine one instantiation of which for user 12 is shown as book marking engine 20. Similar instantiations of single user's book mark engine 20 are available for other users such as book mark users 14, 16 and 18 to record and revisit web resources, such as web sites, located by connection to the World Wide Web on the Internet or similar networking systems. Each instantiation of the book marking engine may include a separate book mark user's index, such as index 36, or a common or master book mark index 24 may preferably be used which includes all the indexed information for all book mark users.

Book mark and result delivery system 10 may also include search result delivery engine 26 which may provide search results to search engine user 28 via search engine site 30.

Single user's book marking engine instantiation 20 may be used by book mark user 12 to save any item having a World Wide Web URL, such as a web site or other web resource found by searching for example via search engine site 30. The title and link to each saved item may be saved in user's book mark list 32 and may be presented to user 12 when appropriate as a book mark or favorite web site or other web resource. The full-text of the book marked item, that is, the full text available at the book marked URL, may be saved or cached in a private repository such as private archive 34. User 12 has full access to private archive 34, but no other user is permitted to access the cached copies in private archive 34.

An index, such as user's index 36, may be built from the full-text of every cached item in private archive 34 for each user. This enables user 12, for example, to perform a search via user's search engine 38 of private archive 34. Items in private archive 34 matching items in a query from user's search engine 38 are presented as search results to user 12, for example, in a list. User 12 may then selectively retrieve either the cached copy of any of the search results listed or access the then-currently-available item at the original URL at the source web site. In some circumstances, the cached copy and the item then currently available at the source web site may be different because the cached copy is a copy made at an earlier time.

Single user's book marking engine 20 may also provide recommendations to user 12 via recommendation engine 40 of items that may be of interest to user 12. Although various forms of recommendations may be made and/or delivered in various ways, four specific types of recommendations are disclosed as exemplars. In particular, recommendations may be selected or compiled by popularity engine 42, subscription engine 44, saved by other saver's engine 46 and similar users engine 48.

Book marks, and their corresponding items, may be marked private by the originating book mark user and therefore may not be shown to others. Such book marks and saved items marked private are not considered to be public and are therefore not included in recommendation lists from recommendation engine 40. If, however, a book mark or saved item is marked private by one user and not by another, the book mark and saved item not marked private may be considered to be public and included in recommendations provided by engine 40.

Popularity engine 42 may provide lists via recommendation engine 40 to users, such as user 12, of public URLs and saved items that have been selected because they meet certain criteria (such as, “most popular today” or “most recently saved”). Such lists can be derived and displayed in real-time, on a web site or via a syndication protocol such as RSS. For example, the top ten most popular URLs may be a list of the ten URL's which have been publicly bookmarked by more book mark users, such as user 12, during the last period, such as the most recent 24 hours or during the current calendar day.

Recommendations, or notices such as emails, may be automatically sent to book mark users, such as user 12, on a predetermined basis or as a result of an action by the user such as logging onto system 10 or initiating a search.

Subscription engine 44 may permit a user, such as user 12, to subscribe to the public book marks and saved items of another user, such as user 14. For example, user 12 could then automatically be notified of all book marks and items publicly saved by user 14. Recommendation engine 40 may cause book marks and items publicly saved by user 14 to be displayed to user 12 in different manners including in a list of headlines or other new item notifications for user 12, in an email notification to user 12 and/or upon request by user 12. When user 12 first initiates a subscription to bookmarks and items publicly saved by user 14, user 14 may be notified of the existence of the subscription. User 14 may be given the option of declining that subscription in which case user 12 will not be permitted to subscribe to user 14.

“Saved by other saver's” engine 46 may also provide recommendations to user 12, for example, via recommendation engine 40. For example, when user 12 publicly book marks, saves, views, or otherwise accesses a particular item, engine 46 may determine that the same item was publicly saved, perhaps within a predetermined time period in the past, by other users, such as user 16 and user 17. User 12 may then be notified of other items saved by user 16 and user 17 that may be of interest to user 12. A search engine, such as user's search engine 38, a master search engine used by system 10 to provide search engines for the users, or a simple key word searching or other engine not shown, may compare portions of the item saved by user 12 to the other items saved by user 16 and user 17 to determine the composition and ranking of the items to be provided to user 12 as recommendations based on the actions of user 16 and user 17.

Similar users engine 48 may also provide recommendations to user 12 for example via recommendation engine 40. Engine 48 compares the public book marking activity of other users to user 12 and identifies similar users to recommend, based on a number of criteria, such as URLs, domain names, descriptions, key word matches, and pattern of saving activity. For example, engine 48 may utilize a threshold level of similarity, such as the number of key word matches or the number of matching saved items, to identify another user, such as user 18, to have similar patterns of saving items to user 12. Thereafter engine 48 may cause user 12 to be notified of items saved by user 18.

Similarly, recommendation engine 40 may use other techniques to determine which other saved items, and other users, are most likely to be of interest to a particular user such as user 12, and provide user 12 with recommendations and/or notifications based on such determinations. This information may be provided to user 12 on a push basis, such as periodically or for otherwise occurring predetermined events such as the saving or other activity by user 12 or by other users, or on a pull basis such as by a request or search by user 12.

The items to be provided to user 12 may be ranked for example on the basis of the likelihood of their interest to user 12 and/or marked for example by color to indicate their ranking. For convenience, each recommended item may easily be selected, or eliminated, by user 12 from the recommendation results by clicking on an appropriate icon associated with each item.

Each recommendation type, such as recommendations based on popularity or similar patterns, may be provided to the user directly from each engine or via recommendation engine 40. In particular, engine 40 may combine various types of recommendations and combine them for example by ranking and/or the method (push or pull) and other details of providing them to the user.

User 12 may also be able to set preferences for each type of recommendation and combinations of recommendation. User 12 may also be permitted to search directly for other users based on first, last or user name. User 12 may also be permitted to directly view all book marks or saved items not marked private, including tags, ratings and other metadata supplied by the saving user.

All users, for each item that is saved, can specify metadata about the items including, but not limited to: title, tags, categories, topics, keywords, date, URL, referring URL, rating, comments, quotations from the item, author, publication date, source, ISBN or ISSN, library cataloging data, date stamps and bibliographic data. One or more of the metadata elements for a particular item may be supplied automatically by book marking engine 20 at the time of book marking or saving. For example, user 12 may decide that all items such as URLs accessed, viewed or saved between a first time and a second time should belong to a particular task, such as billing task #n. User 12 may then select a preference, including a start time, after which all such items would automatically have included in the metadata associated with each such item a reference to billing task #n. At the end of the search associated with billing task #n, user 12 may then select as a further preference a stop time after which such items would no longer have a reference to billing task #n automatically added to the metadata for those items.

All users can search their own private archives such as archive 34, and limit their search results by date, category, rating, or any other specified metadata. For example, user 12 may search the private archive for user 12 to retrieve all items whose metadata includes a reference to billing task #n.

Further, metadata to be automatically added to the metadata for particular items may be automatically derived from specified metadata in the item. For example, URLs in the item linking to a commercial site at which a product related to the saved item may be bought or sold. Such URLs may be detected by recognizing URLs of prominent commercial sites such as amazon.com, ebay.com, etc. from a predetermined list. The metadata automatically inserted may be inserting an applicable affiliate code (i.e., a string inserted into the URL to identify a web site operator who receives a commission or payment of some kind related to commercial traffic driven to the site). Such URLs may also be constructed by recognizing books, magazines, and other commercial objects referenced on the saved or book marked document, and building a URL to purchase or sell said objects, including an applicable affiliate code, on a commercial site.

Such URL metadata may be used to cause the identified web site operator to receive a commission or other payment from a commercial site when user 28 performs an act, such as buying the specified item from the commercial site, which contractually requires payment from the commercial site to the web site operator providing the link to the commercial site to user 28.

All users may have access to functions of system 10, such as save, view, retrieve from cache, edit, search, find user, subscribe, view headlines, or other functions, via a web site interface or through an API (application programming interface) over the World Wide Web.

Access to data for recommendation engine 40, as well as engines 42, 44, 46 and 48, may be provided from data base 50, which receives public data from private archive 34 and/or user's index 36. Data may also be provided from master book mark index 24 which is an index of database 50.

Book mark and result delivery system 10 may also be used to deliver highly-relevant search results from a database of documents, such as database 50 and/or master index 24, based on the combination of all users book marking engines, such as engine 20. System may include other sources of data, rather than the combination of user's engines, where the ranking of the data or results is dependent upon the voting, rating, and other metadata and activities of the users of the system, and where the document set itself is selected based on the activities of the users of the system.

For example, engine 20 may be one of a series of single user book marking engines forming data engines 52. Alternately, engines 52 may include other types of data engines or sources of data or results as long as the data or results includes ranking or other comparative data dependent on metadata at least in part supplied by, and/or activities of, the users of the system and/or the items in the set of data and/or results are selected based on the actions of the users of the system.

In a preferred embodiment, data engines 52 provides a focused index of websites, and other web resources in the World Wide Web, that is the public Internet, built from items saved in the book marking system disclosed in which engine 20 is an exemplar of one of many single user's book marking and searching activities. Other types of book marking systems may also be used as well as other sources of such focused data. Similarly, database 50 may be a separate data base or a compilation or combination of indexes or the like, such as user's index 36, in data engines 52.

Similarly, master book mark index 24 may be a separate index as shown in FIG. 1 or a compilation of the various user's indexes. In any event, in operation, search results delivery engine 26 may start by extracting a list of URLs and/or other items together with data related to the saving of each URL or item. For example, in a system in which each data engines 52 is a single book mark user's engine such as engine 20, a list of all user's book marked URLs and/or other saved items may be extracted as list 54. List 54 may be considered to be a database in which metadata about the activities of the users is stored with each URL or other stored item, such as the number of users on data engines 52 which have book marked and/or saved each particular URL or other item. The metadata may include, or be computed to include meta ranking data, that is, data such as an average numeric ranking of each saved URL or other item indicating the quality of the URL or other item for a specific purpose.

Web crawler 56, or a similar technique, may then be used to collect and or update a collection of saved copies of the URLs or other data collected by crawler 56, together with the ranking meta data from list 54 or from index 24, database 50 or otherwise from data engines 52, in a data store of book marked pages or other saved items, such as data store 58. Index 60 of data store 58 is then created or updated.

Search engine 62 may then access data store 60 in response to query handler 64 to determine matches or partial matches in data store 60 for queries received from search engine site 30. A result set from search engine 62, appropriately matching the query from search engine user 28, may be provided to user 28 directly by search engine site 30 or indirectly by conventional redirect mechanisms.

The results provided to user 28 may be ranked on various criteria including based on meta ranking data provided as described above. Each result may be displayed with various information elements including data derived from the meta ranking data as well as links back to a bookmark or other source system represented by engines 52.

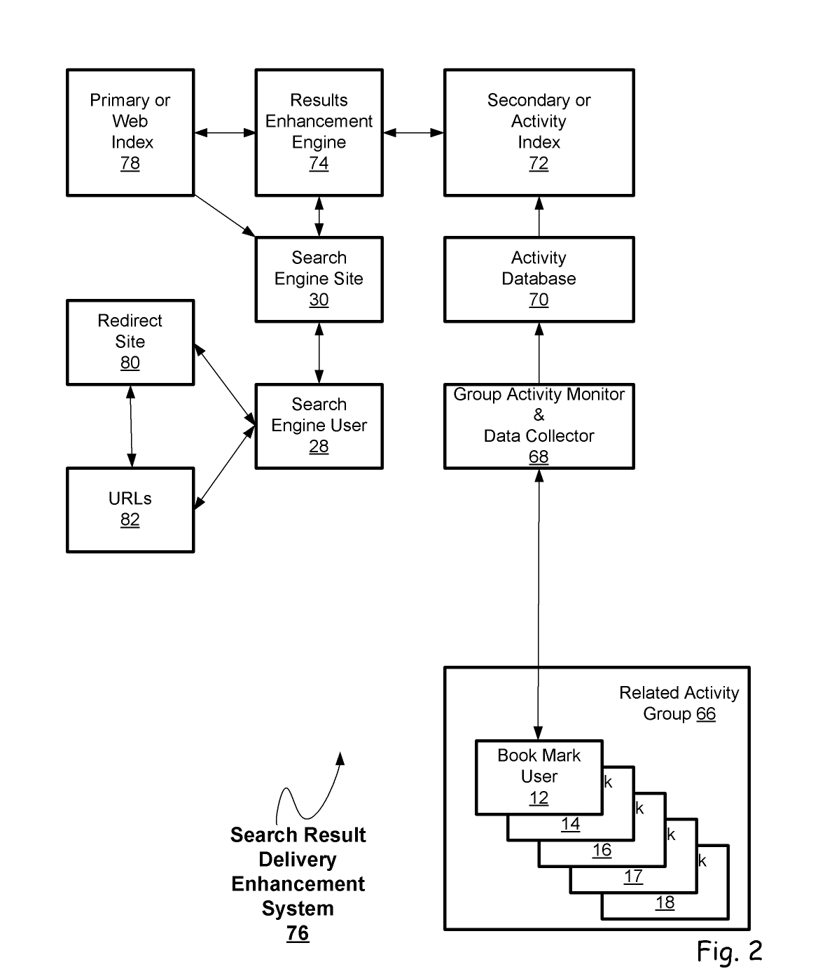

Referring now to FIG. 2, a more generic form of the system of FIG. 1 is described in which search results may be enhanced by search result enhancement system 76. A selected group of actors, such as book mark users 12, 14, 16 and 18, that is, the activities of a particular group acting in a known or predictable self-interested manner, may be monitored to collect data by group activity and data collector 68. In the embodiment described in FIG. 1, for example, the activity monitored may be the saving of particular items by book mark users. Other possible activity groups may be selected groups of web sites including search engines whose activities may be monitored. The data collected by monitor and data collector 68 may be saved in activity database 70 and then indexed in secondary or activity index 72 or the activity data may indexed directly in secondary index 72 without the use of a separate database.

In any event, it is preferable to build secondary index 72 before search engine user 28 queries search engine site 30.

Referring now to a conventional search which may be initiated by search engine user 28, search engine site 30 may retrieve search results from primary or web index 78 in response to the query from user 28, for example, by selecting entries in web index 78 which match key words derived from the query provided by user 28. Conventionally, result sets may be returned to user 28 from search engine site 30 so that user 28 may download related URLs 82 directly or via a redirect site such as site 80. Many variations are known for conventional searching.

In accordance with this embodiment, the raw search result set from primary or web index 78 may be applied to results enhancement engine 74 for improvement before being provided to user 28. For example, the raw search results may be enhanced by ranking based on the contents of each indexed item in web index 78 (which may be considered to be an intrinsic ranking) and/or the raw search results may be enhanced by ranking based on the extraction of links within each indexed item in web index 78.

Preferably, the raw search results may be ranked by a combination of intrinsic and extrinsic rankings as described in U.S. patent application Ser. No. 09/757,435 filed Jan. 10, 2001 and incorporated herein by reference. Further, the raw search results may be ranked by voting as described herein in U.S. patent application Ser. No. 09/947,557 filed Sep. 6, 2001 and incorporated herein by reference. Ranking by voting may be combined with ranking by extrinsic and intrinsic ranking.

Results from results enhancement engine 74, in addition to the use of such ranking techniques based on the items selected for the result set in accordance with the indexed URLs may also be ranked or otherwise enhanced in engine 74 in accordance with secondary index 72. For example, as described above with regard to FIG. 1, URLs saved by bookmark users 12, 14, 16 and/or 18 which are indexed in secondary index 72 and bear some relationship to the query from user 28 by for example including one or more of the key words in that query, may be added to the result set provided to user 28. Further, weighting based on the number of book mark users saving the same URL may be used to provide a further ranking of the result set to be provided to user 28.

1. A method of enhancing search results provided over the Internet, comprising:
providing a service over the Internet to members of a group of service users, the service resulting in multiple selections of each of a plurality of web pages by different members of the group;
maintaining a first database of web pages selected by members of the group;
maintaining a first index of web pages from the first database excluding identification of members of the group;
maintaining a global index of web pages;
searching the first index and the global index in response to a query string provided by a search engine user; and
providing a search results set to the search engine user including search results from both the first index and the global index.

2. The method of claim 1 wherein providing a service to a group of service users further comprises:
providing book marking services to the group to allow each member of the group to retrieve links to web pages previously viewed by that member.

3. The method of claim 2 wherein providing book marking services further comprises:
maintaining a private archive, exclusively searchable by each member, of web pages book marked by that member.

4. The method of claim 3 wherein maintaining a private arching further comprises:
maintaining an index of each member's private archive;
responding to a search request from a particular member by searching the index of that member's private archive to provide a search results set; and
selectively providing, to that member, the web page corresponding to a link in the search results set from the archive or providing the web page currently corresponding to the link.

5. The method of claim 2 wherein providing book marking services further comprises:
maintaining a common archive of web pages book marked by any member of the group.

6. The method of claim 5 wherein maintaining the common archive further comprises:
maintaining a common archive of web pages book marked by any member of the group unless marked private by that member.

7. The method of claim 5 wherein maintaining the common archive further comprises:
including a web page bookmarked and not marked private by a first member of the group even if that web page was bookmarked and marked private by another member of the group.

8. The method of claim 5 wherein providing book marking services further comprises:
providing recommendations to a member of the group of web pages of interest to that member of the group.

9. The method of claim 8 wherein providing recommendations further comprises:
providing recommendations to individual members of the group based on a predetermined measure related to popularity of the web pages recommended.

10. The method of claim 9 wherein providing recommendations further comprises:
recommending a web page from the common archive based on book marking of that page by other members of the group.

11. The method of claim 8 wherein providing recommendations further comprises:
providing recommendations to a first member of the group of web pages bookmarked by a second member of the group if the first member subscribes to recommendations based on the second member's book marks.

12. The method of claim 8 wherein providing recommendations further comprises:
determining when a first member of the group performs an operation on a first web page on which a second member of the group has performed an operation; and
recommending other web pages in the common archives on which the second member has performed operations, to the first member.

13. The method of claim 12 wherein the operations performed are selected from a group of operations comprising book marking, saving, viewing and accessing.

14. The method of claim 8 wherein providing recommendations further comprises:
comparing the book marking activity of a first member to the book marking activity of a second member; and
recommending book marks made by the second member to the first member if a predetermined threshold of similarly is achieved.

15. The method of claim 8 wherein providing recommendations further comprises:
ranking recommendations provided to a member based on a likelihood of interest of each such recommendation to the member.

16. The method of claim 8 wherein providing recommendations further comprises:
sending the recommendations to the member upon the occurrence of a predetermined event.

17. The method of claim 16 wherein the predetermined event is completion of a period of time.

18. The method of claim 8 wherein providing recommendations further comprises:
sending the recommendations to the member in response to an action taken by the member.

19. The method of claim 17 wherein the action taken is selected from a group of actions comprising logging into the service, requesting recommendations and submitting a search request.

20. The method of claim 3 wherein providing book marking services further comprises:
recording metadata specified by a first member to be associated with a web page in the private archive maintained for the first member.

21. The method of claim 3 wherein providing book marking services further comprises:
automatically recording metadata related to a web page book marked by a member; and
using the recorded metadata to qualify for remuneration from an entity offering remuneration associated with activities related to the web page.
